(19) United States
(12) Patent Application Publication
(10) Pub. No.: US 2026/0094545 A1
(43) Pub. Date: Apr. 2, 2026

(54) SIGN MOUNTING SYSTEM AND ELONGATED SIGN MOUNTING MEMBER THEREFOR

(71) Applicant: Lind SignSpring Group, LLC, Mansfield, OH (US)

(72) Inventor: John L. SIEGENTHALER, Mansfield, OH (US)

(21) Appl. No.: 19/180,516

(22) Filed: Apr. 16, 2025

Related U.S. Application Data
(60) Provisional application No. 63/661,661, filed on Jun. 19, 2024.

(51) Int. Cl. G09F 7/18

(52) U.S. Cl. CPC G09F 7/18; G09F 2007/1843; G09F 2007/1886

(57) ABSTRACT

A sign mounting system for tautly mounting a flexible material sign to an associated sign structure includes a plurality of elongated sign mounting member assemblies adapted to be mounted to the associated sign structure to define a perimeter for the flexible material sign. At least one of the plurality of elongated sign mounting member assemblies includes an elongated base member adapted to be mounted to the associated sign structure, at least one mounting spring for tautly mounting the flexible material sign to the base member, the at least one mounting spring having a first end secured to the base member and a second end secured to the flexible material sign, and an elongated cover member complementarily and removably secured to the elongated base member for covering the at least one mounting spring. The elongated cover member is flexibly hinged to the elongated base member for allowing access to the at least one mounting spring.

This application claims the benefit of U.S. provisional patent application Serial No. 63/661661, filed June 19, 2024, which is incorporated by reference in its entirety herein.

### BACKGROUND

The present disclosure relates generally to sign mounting systems, and more particularly to a sign mounting system for tautly mounting a flexible material sign to an associated sign structure.

Flexible material signs or displays, such as those constructed of vinyl, are increasingly being used in the marketplace. These types of signs are generally lightweight and relatively inexpensive to manufacture. A variety of methods are known for mounting these types of signs to associated sign structures (e.g., billboard structures, building walls, truck trailers, other sign structures, etc.). One known system and method for tautly mounting a sign is disclosed in U.S. Patent No. 7,168,197, expressly incorporated herein by reference. Another known system and method for tautly mounting a sign is disclosed in U.S. Patent No. 8,561,330, expressly incorporated herein by reference.

Despite these known systems, there remains a need for improved sign mounting systems that provide impact resistance, protection for mounting components, and ease of installation and maintenance.

### BRIEF DESCRIPTION

According to one aspect, a sign mounting system for tautly mounting a flexible material sign to an associated sign structure includes a plurality of elongated sign mounting member assemblies adapted to be mounted to the associated sign structure to define a perimeter for the flexible material sign. At least one of the plurality of elongated sign mounting member assemblies includes an elongated base member adapted to be mounted to the associated sign structure, and at least one mounting spring for tautly mounting the flexible material sign to the base member. The at least one mounting spring has a first end secured to the base member and a second end secured to the flexible material sign. The at least one of the plurality of elongated sign member assemblies further includes an elongated cover member complementarily and removably secured to the elongated base member for covering the at least one mounting spring.

According to another aspect, an elongated sign mounting member assembly for a sign mounting system for tautly mounting a flexible material sign to an associated structure includes an elongated base member adapted to be mounted to the associated sign structure, at least one mounting spring for tautly mounting the flexible material sign to the base member, wherein the at least one mounting spring having a first end secured to the base member and a second end secured to the flexible material sign, and an elongated cover member complementarily and removably secured to the elongated base member for covering the at least one mounting spring.

Advantageously, the elongated cover member provides impact resistance for protecting the at least one mounting spring, which is particularly beneficial in installations where the sign may be subjected to impacts, such as in athletic fields. Additionally, the cover member is flexibly hinged to the base member, allowing convenient access to the mounting springs during installation or removal of the sign.

### BRIEF DESCRIPTION OF THE DRAWINGS

FIG. 1A is a front elevation view of a sign mounting system tautly mounting a flexible material sign to an associated sign structure (e.g., a fence).

FIG. 1B is a front side perspective view of the sign mounting system of FIG. 1.

FIG. 1C is back side perspective view of the sign mounting system of FIG. 1.

FIG. 2 is a partial end perspective view an elongated sign mounting member assembly according to an exemplary embodiment.

FIG. 3 is a top plan perspective view of a cover member of the elongated sign mounting member assembly of FIG. 2.

FIG. 4 is a top plan perspective view of an elongated base member and a spring member mounted thereto, both of the elongated sign mounting member assembly of FIG. 2.

FIG. 5 is an end elevation perspective view of the elongated base member and spring member, both of FIG. 4.

FIG. 6 is an end elevation view of the elongated sign mounting member assembly of FIG. 2.

FIG. 7 is a perspective view showing the cover member being flexibly moved relative to the elongated base member to provide access to the mounting spring.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as "substantially" and "approximately" means a reasonable amount of deviation of the modified word is contemplated such that the end result is not significantly changed.

### Overview of the Sign Mounting System

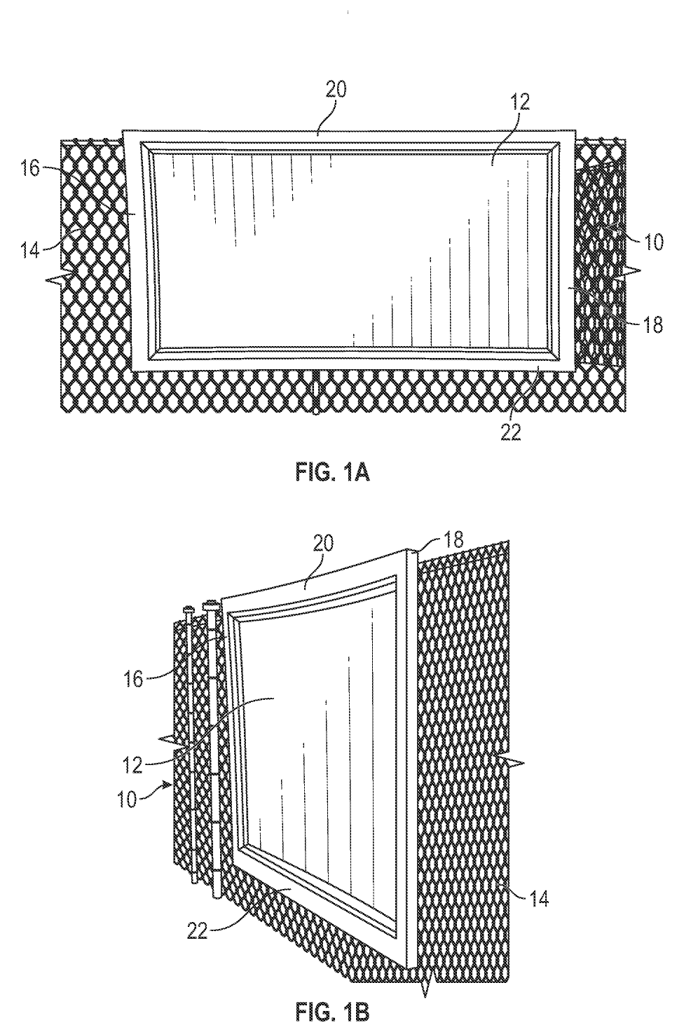

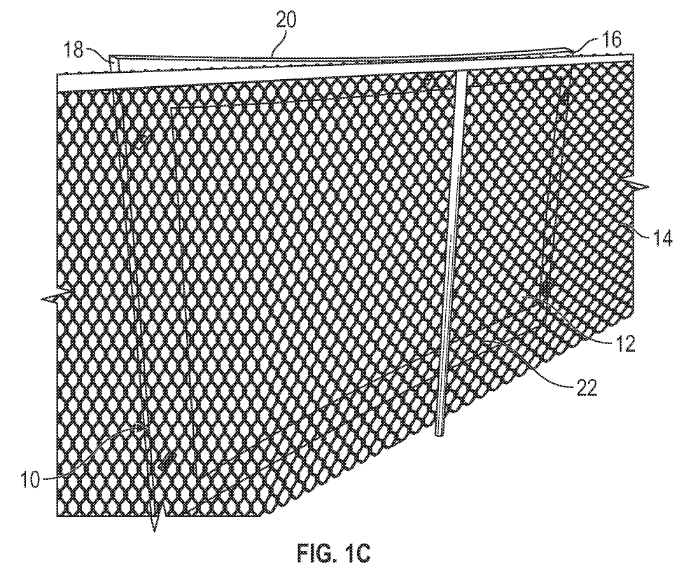

With reference now to the drawings, wherein like numerals refer to like parts throughout the several views, FIGS. 1A-1C shows a sign mounting system 10 for tautly mounting a flexible material sign 12 to an associated sign structure 14. In particular, in FIGS. 1A-1C, the associated sign structure 14 is illustrated as a fence, particularly a chain link fence. While shown as a fence, it is to be understood and appreciated that the sign structure 14 can be any structure to which a flexible material sign is to be mounted and that the sign 12 can be of any known construction, such as from polyethylene, vinyl, or other similar flexible materials. The flexible material sign 12 may include printed indicia, graphics, advertisements, information, or other visual content as desired for the particular application.

The sign mounting system 10 of FIG. 1 includes a plurality of elongated sign mounting member or member assemblies 16, 18, 20, 22 adapted to be mounted to the sign structure 14 to define a perimeter for the flexible material sign 12. In particular, the plurality of elongated sign mounting members 16, 18, 20, 22 includes a left side member 16, a right side member 18, a top member 20 and a bottom member 22. Together, these mounting members create a frame-like structure that securely holds the flexible sign material in a taut configuration, providing improved visibility and resistance to environmental factors such as wind.

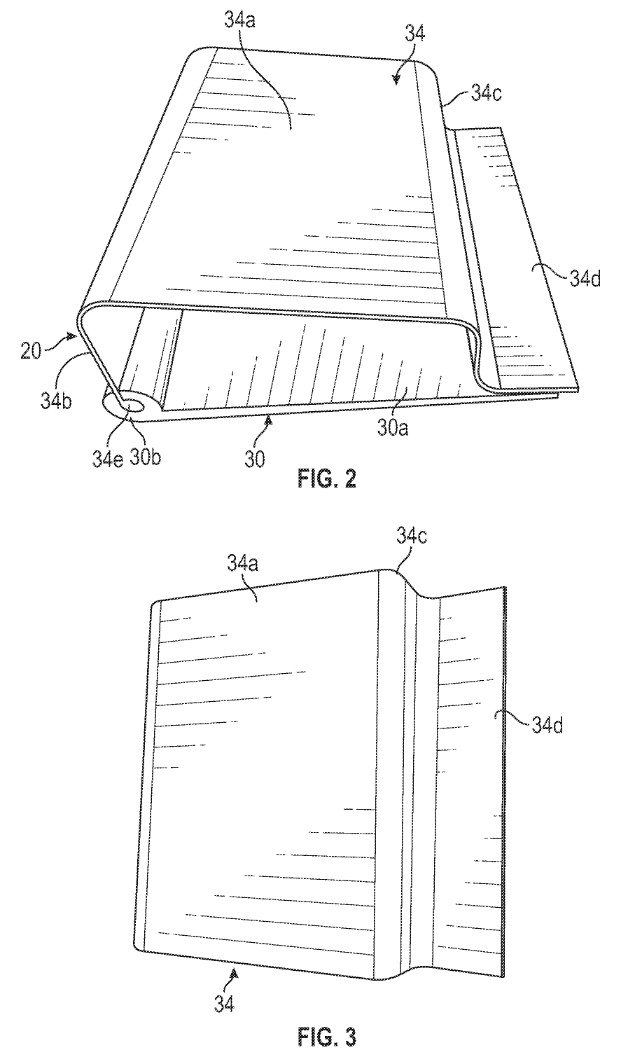

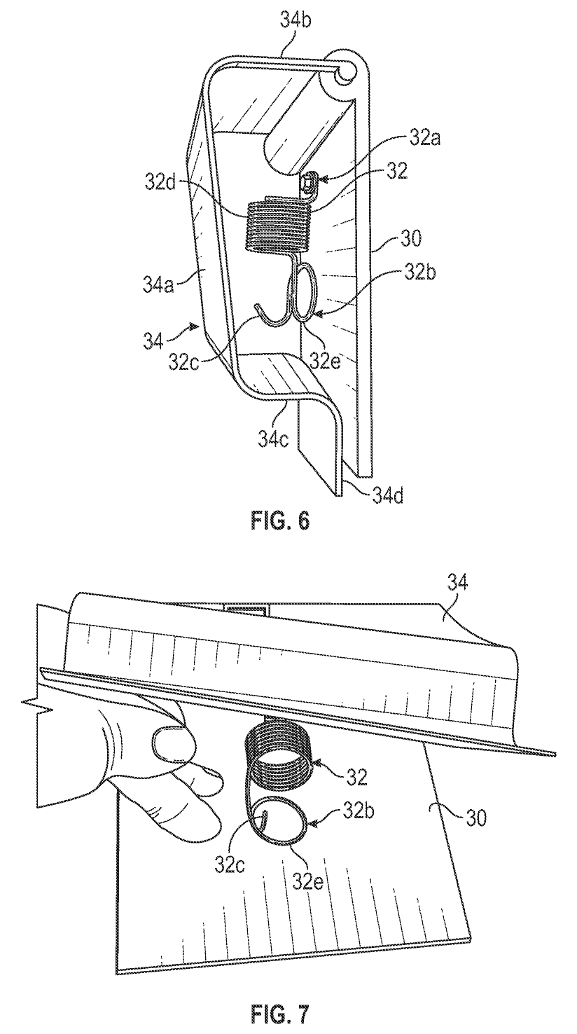

With additional reference to FIGS. 2-6, at least one of the plurality of elongated sign mounting member 16, 18, 20, 22, for example top mounting member assembly 20, can include an elongated base member 30, at least one mounting spring 32 and an elongated cover member 34. Optionally, all the members 16, 18, 20, 22 can be formed like the top mounting member assembly 20, though this is not required. For example, it is contemplated that only the top mounting member 20 could be formed as described in reference to FIGS. 2-6, only the top member 20 and the bottom member 22 could be formed as described in reference to the top member 20 in FIGS. 2-6, only the side members 16, 18 could be formed as shown and described in reference to FIGS. 2-6 or any other combination. This modular approach provides flexibility in designing the mounting system for different applications and environments. Notably, FIGS. 2-6 illustrate only a small section of the top member assembly 20 of FIGS. 1A-1C.

### Installation and Mounting

The sign mounting members 16, 18, 20, 22 can be secured to the sign structure 14 through any known means. For example, the sign mounting members 16, 18, 20, 22 can be secured to the fence 14 of FIGS. 1A-1C with any suitable fastener, such as Zip cable ties, bolts, fence sign mounting fastening clips, brackets, etc. The choice of fastener may depend on the specific sign structure and the expected environmental conditions. For permanent installations, more robust fastening mechanisms such as bolts or brackets may be preferred, while temporary installations might benefit from easily removable fasteners such as cable ties. In some installations, the fence 14 could be provided in an area likely to receive impact, such as an outfield fence provided on a baseball diamond. In such high-impact applications, the protective aspects of the present invention provide significant advantages over conventional sign mounting systems that leave mounting components exposed to potential damage.

### Detailed Component Structure

As shown in FIGS. 2-6, the top member or top member assembly 20 includes the elongated base member 30 that is adapted to be mounted to the associated sign structure 14, i.e., the fence in FIGS. 1A-1C. The elongated base member 30 provides structural support for the assembly and serves as an attachment point both to the sign structure and to the flexible sign material. The top member assembly 20 additionally includes at least one mounting spring 32 for tautly mounting the flexible material sign 12 to the base member 30. The mounting spring 32 is a key component that provides tension to maintain the sign in a taut condition while also allowing for some flexibility during environmental stresses such as wind gusts.

As will be understood and appreciated by those skilled in the art, each of the at least one mounting springs 32 can include a first end 32a secured to the base member 30, such as by a fastener (e.g., a screw or rivet) and a second end 32b secured to the flexible material sign 12. The top member assembly 20 further includes the elongated cover member 34 complementarily and removably secured to the elongated base member 30 for covering the at least one mounting spring 32 as will be described in more detail below. The cover member 34 not only provides aesthetic benefits by concealing the mounting hardware but also offers significant protection from impacts and environmental factors. It should be appreciated that the at least one mounting spring 32 can be a plurality of mounting springs (not shown) disposed along the length of the top member 20 in spaced apart relation. In embodiments using multiple springs, the springs may be evenly spaced to provide uniform tension across the sign, or strategically placed to accommodate particular stress points depending on the sign structure and expected environmental conditions.

### Mounting Spring Configuration

In one embodiment, the mounting spring 32 can be one of the springs disclosed in commonly owned US Patent No. 8,561,330, expressly incorporated herein by reference. For example, the mounting spring 32 can include a base portion, which is the first end 32a, that can be secured to base member 30. Additionally, the mounting spring 32 can include a grasping portion, which is the second end 32b, including a finger 32c received through an aperture (not shown) of the flexible material sign 12. This grasping arrangement provides a secure connection that distributes tension across the sign material, reducing the risk of tearing or material failure at connection points. Still further, the mounting spring 32 can include a coiled spring portion 32d disposed between the base portion 32a and the grasping portion 32b to apply a tension to the flexible material sign 12. The spring portion 32d absorbs and distributes forces that might otherwise damage the sign or cause it to tear away from its mounting points. The mounting spring 32, and particularly the spring portion 32d thereof, can be a coiled spring, which provides excellent resilience and durability in outdoor applications.

As shown, the grasping portion 32b on the mounting spring 32 can include a looped portion 32e for applying a tension force on the grasping portion 32b, such as manually via a person's finger, for applying a tension force on the grasping portion 32b relative to the base portion 32a to longitudinally move the grasping portion 32b relative to the base portion 32a by stretching the spring portion 32d. This looped design facilitates installation and adjustment of the sign tension without requiring specialized tools. The base portion 32a can include a hooked or looped portion 32f adapted to be secured to base member 30. This configuration allows for easy installation and replacement of individual springs if maintenance is required, without necessitating replacement of the entire assembly.

### Base Member Structure

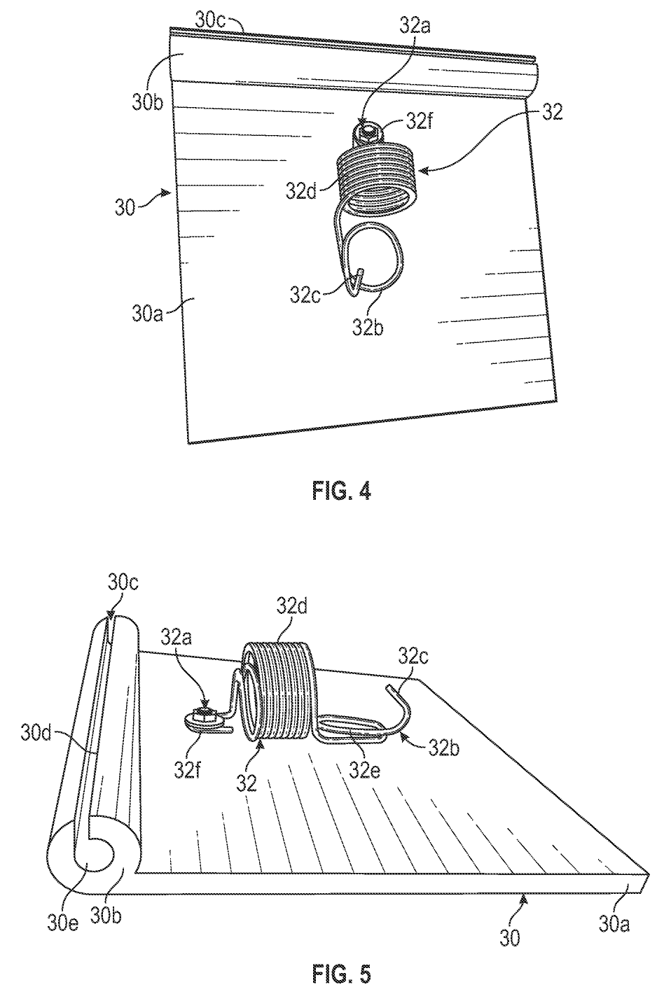

As best shown in FIGS. 4 and 5, the elongated base member 30 can include a planar portion 30a and a mounting portion 30b defining a groove 30c therein into which the elongated cover member 34 is complementarily and removably secured to the elongate base member 30. The planar portion 30a provides a stable mounting surface that can be attached to the sign structure, while also supporting the spring 32. In particular, the groove 30c can be defined as having a slit portion 30d through which the elongated cover member 34 is received and an enlarged base portion 30e into which the elongated cover member 34 is received. This groove configuration creates a secure yet flexible connection between the base member and cover member.

The enlarged base portion 30e is sized larger than the slit portion 30d to prevent pull-out of the elongated cover portion 34 through the slit portion 30d of the groove 30c, providing mechanical retention while still allowing the hinging action described below. As shown, in the illustrated embodiment, the mounting portion 30b is cylindrical shaped and is disposed at one end of the planar portion 30a. The cylindrical shape provides strength while minimizing material usage. The slit portion 30d is perpendicularly oriented relative to the planar portion 30a. The enlarged base portion 30e can be defined as a bore extending along an entirety of the mounting portion 30b and the elongated base member 30. This continuous bore design simplifies manufacturing while maintaining structural integrity throughout the length of the member.

### Cover Member Structure

The elongated cover member 34 includes a cover portion 34a and a mounting portion 34b adapted to removably mount the cover member 34 to the elongated base member 30 and extend in a direction away from the elongated base member 30. This configuration creates a protective enclosure for the mounting springs, such as spring 32, while maintaining the aesthetic appearance of the sign installation. As shown, the cover portion 34a is spaced apart from the planar portion 30a of the elongated base member 30 by the mounting portion 34b, creating a protected space for the mounting springs to operate while shielding them from external impacts.

In the illustrated embodiment, the mounting portion 34b is a wall structure oriented approximately perpendicularly relative to the planar portion 30a of the elongated base member 30 when the cover portion 34a is removably secured to the elongated base member 30. This perpendicular orientation provides structural rigidity to the cover member while facilitating the hinged movement described below. The cover portion 34a is a wall structure angled relative to the planar portion 30a when the cover portion 34a is removably secured to the elongated base member 30. This angled configuration provides enhanced impact resistance by deflecting forces away from the mounting springs and connection points. The mounting portion 34b includes an enlarged portion 34e disposed at its distal end for complementary receipt in the enlarged base portion 30e of the groove 30c. This enlarged portion creates a secure mechanical interlock between the cover member and base member while still allowing for the controlled hinged movement.

The elongated cover member 34 can further include a distal wall portion 34c extending from the cover portion 34a toward or to the planar portion 30a of the elongated base member 30 when the cover portion 34a is removably secured to the elongated base member 30. This distal wall portion completes the protective enclosure around the mounting springs while providing additional structural integrity to the cover member. The elongated cover member 34 can further include a mating flange 34d extending from a distal end of the distal wall portion 34c and oriented so as to be approximately parallel to the planar portion 30a when the cover portion 34a is removably secured to the elongated base member 30. This mating flange provides a smooth finished edge to the assembly and can also serve as a contact point or stop that limits the closure of the cover member against the base member, preventing over-compression of components.

### Flexible Hinge Functionality

With reference to FIG. 7, the elongated cover member 34 is flexibly hinged to the elongated base member 30 for allowing access to the at least one mounting spring 32. This hinged design represents a significant advantage over prior art systems, as it allows for convenient access to the mounting components for installation, adjustment, or replacement without requiring complete disassembly of the sign system. More particularly, the cover portion 34a is flexible relative to the planar portion 30a of the elongated base member 30 for allowing access to the at least one mounting spring 32. This may be desirable when installing or removing a flexible sign 12 from the mounting spring 32. The ability to simply open the cover member like a hinged door significantly reduces installation and maintenance time compared to systems requiring complete removal of protective components.

To provide this flexibility, at least the cover member 34 can be formed of a flexible material, preferably a flexible material that can be extruded. In one example, the cover member 34 can be formed of polyvinyl chloride (PVC), which provides excellent durability, UV resistance, and appropriate flexibility for the hinging action. The PVC material also offers good impact resistance and can be formulated with various additives to enhance weather resistance for outdoor applications. Optionally, the base member 30 can also be formed of the same flexible material as the cover member 34, which can simplify manufacturing and ensure material compatibility. Advantageously, the elongated cover member 34 by its shape and/or material composition can provide impact resistance for protecting the at least one spring 32, particularly in applications such as athletic fields where the sign mounting system may be subjected to frequent impacts.

### Manufacturing and Alternative Embodiments

The elongated base member 30 and elongated cover member 34 may be manufactured using extrusion processes, allowing for cost-effective production of consistent profiles in various lengths. The extrusion process also facilitates the creation of the complex cross-sectional shapes required for the interconnecting features of the base and cover members. While PVC has been described as a preferred material, other suitable materials may include various thermoplastics, elastomers, or composite materials that provide the desired combination of flexibility, durability, and weather resistance.

In alternative embodiments, the mounting system may include additional features such as integrated channels for water drainage, textured surfaces for improved grip during installation, or color-matched components to blend with the sign or surrounding structure. The system may also be scaled to accommodate signs of various sizes and weights by adjusting the dimensions and spring tensions accordingly.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A sign mounting system for tautly mounting a flexible material sign to an associated sign structure, comprising:
a plurality of elongated sign mounting member assemblies adapted to be mounted to the associated sign structure to define a perimeter for the flexible material sign;
wherein at least one of the plurality of elongated sign mounting member assemblies includes:
an elongated base member adapted to be mounted to the associated sign structure,
at least one mounting spring for tautly mounting the flexible material sign to the base member, the at least one mounting spring having a first end secured to the base member and a second end secured to the flexible material sign; and
an elongated cover member complementarily and removably secured to the elongated base member for covering the at least one mounting spring.

2. The sign mounting system of claim 1 wherein the elongated base member includes:
a planar portion; and
a mounting portion defining a groove therein into which the elongated cover member is complementarily and removably secured to the elongated base member.

3. The sign mounting system of claim 2 wherein the groove is defined as having a slit portion through which the elongated cover member is received and an enlarged base portion into which the elongated cover member is received, the enlarged base portion being sized larger than the slit portion to prevent pull-out of the elongated cover member through the slit portion of the groove.

4. The sign mounting system of claim 3 wherein the mounting portion is cylindrical shaped and is disposed at one end of the planar portion, and the slit portion is perpendicularly oriented relative to the planar portion.

5. The sign mounting system of claim 4 wherein the enlarged base portion is defined as a bore extending along an entirety of the mounting portion and the elongated base member.

6. The sign mounting system of claim 1 wherein the elongated cover member includes:
a cover portion; and
a mounting portion adapted to removably mount the cover member to the elongated base member and extend in a direction away from the elongated base member.

7. The sign mounting system of claim 6 wherein the cover portion is spaced apart from a planar portion of the elongated base member by the mounting portion.

8. The sign mounting system of claim 6 wherein the mounting portion is a wall structure oriented approximately perpendicularly relative to a planar portion of the elongated base member when the cover portion is removably secured to the elongated base member.

9. The sign mounting system of claim 6 wherein the cover portion is a wall structure angled relative to a planar portion of the elongated base member when the cover portion is removably secured to the elongated base member.

10. The sign mounting system of claim 6 wherein the elongated cover member further includes a distal wall portion extending from the cover portion toward the planar portion of the elongated base member when the cover portion is removably secured to the elongated base member.

11. The sign mounting system of claim 10 wherein the elongated cover member further includes a mating flange extending from a distal end of the distal wall portion and oriented so as to be approximately parallel to a planar portion of the elongated base member when the cover portion is removably secured to the elongated base member.

12. The sign mounting system of claim 6 wherein the cover portion is flexible relative to a planar portion of the elongated base member for allowing access to the at least one mounting spring.

13. The sign mounting system of claim 1 wherein the elongated cover member is flexibly hinged to the elongated base member for allowing access to the at least one mounting spring.

14. The sign mounting system of claim 1 wherein the at least one of the plurality of elongated sign mounting member assemblies is formed of polyvinyl chloride (PVC).

15. The sign mounting system of claim 1 wherein the elongated cover member provides impact resistance for protecting the at least one mounting spring.

16. The sign mounting system of claim 1 wherein the at least one mounting spring includes a coiled spring portion disposed between a base portion secured to the elongated base member and a grasping portion secured to the flexible material sign.

17. The sign mounting system of claim 16 wherein the grasping portion includes a looped portion configured to receive a tension force for stretching the coiled spring portion.

18. The sign mounting system of claim 1 wherein the associated sign structure is a fence, and wherein the at least one of the plurality of elongated sign mounting member assemblies is secured to the fence with fasteners.

19. The sign mounting system of claim 18 wherein the fence is provided in an area likely to receive impact.

20. An elongated sign mounting member assembly for a sign mounting system for tautly mounting a flexible material sign to an associated structure, comprising:
an elongated base member adapted to be mounted to the associated sign structure, the elongated base member including a planar portion and a mounting portion defining a groove therein;
at least one mounting spring for tautly mounting the flexible material sign to the elongated base member, the at least one mounting spring having a first end secured to the elongated base member and a second end secured to the flexible material sign; and
an elongated cover member complementarily and removably secured to the elongated base member for covering the at least one mounting spring, the elongated cover member being flexibly hinged to the elongated base member for allowing access to the at least one mounting spring; and
wherein the groove is defined as having a slit portion through which the elongated cover member is received and an enlarged base portion into which the elongated cover member is received, the enlarged base portion being sized larger than the slit portion to prevent pull-out of the elongated cover member through the slit portion of the groove.
